(19) United States
(12) Patent Application Publication
(10) Pub. No.: US 2026/0088234 A1
(43) Pub. Date: Mar. 26, 2026

(54) Alternating Current Disconnector for Subsea Operation

(71) Applicant: ABB Schweiz AG, Baden (CH)

(72) Inventors: Stian Ingebrigtsen, Bergen (NO); Oistein Martinsen, Bærums Verk (NO); Harald Fretheim, Aurskog (NO); Henning Caillé Nesheim, Stabekk (NO); Tako Lootsma, Billingstad (NO); Olav Juvstad, Oslo (NO); John Andersen, Oslo (NO); Kai-Arne AA, Fyllingsdalen (NO)

(73) Assignee: ABB Schweiz AG, Baden (CH)

(21) Appl. No.: 19/335,351

(22) Filed: Sep. 22, 2025

(30) Foreign Application Priority Data
Sep. 23, 2024 (EP) 24201854

(51) Int. Cl. H01H 3/24; H01H 9/00; H01H 9/04

(52) U.S. Cl. CPC H01H 3/24; H01H 9/0072; H01H 9/04

(57) ABSTRACT

An alternating current disconnector includes a watertight housing for subsea operation, and a disconnector unit that includes a contact terminal accommodated in the housing; a movable contact arranged in the contact terminal and being movable relative to the contact terminal; and a linear hydraulic actuator arranged inside the contact terminal and being configured to linearly move the movable contact in the contact terminal in two directions for closing and opening a connection with a contact conductor.

### CROSS-REFERENCE TO RELATED APPLICATIONS

The instant application claims priority to European Patent Application No. 24201854.7, filed Sep. 23, 2024, which is incorporated herein in its entirety by reference.

### FIELD OF THE DISCLOSURE

The present disclosure generally relates to an alternating current disconnector for subsea operation.

### BACKGROUND OF THE INVENTION

Offshore power generation installations such as, for example, wind turbines, solar power devices, and wave generated power, have over recent years increased both in size and rated power. The ongoing size and power increase with associated developments leads to logistic challenges with regards to installation and maintenance, in addition to the challenges related to power collection from the respective power generating installations.

With floating wind turbines, or other floating power generation installations, such as floating photovoltaic generators, logistics in installation and power collection and, when relevant, distribution, is challenging. For example, available dynamic cables are currently not qualified with wet design above 72.5 kV, thus limiting floating substations from connecting with large scale offshore wind parks and exporting power to shore.

To alleviate this problem, electrical power systems for subsea operation have been proposed. Utilizing qualified subsea cable technology with subsea substations will simplify cable installation and enable export of large power at longer distances. However, there appears to still be room for improvements for such subsea electrical power systems.

### BRIEF SUMMARY OF THE INVENTION

In view of the above-mentioned and other drawbacks of the prior art, the present disclosure generally describes an alternating current disconnector for subsea operation that at least partly alleviates the deficiencies with prior art.

According to a first aspect, there is provided an alternating current disconnector, comprising: a watertight housing for subsea operation of the alternating current disconnector, a disconnector unit comprising: a contact terminal accommodated in the housing; a movable contact arranged in the contact terminal and being movable relative to the contact terminal; and a linear hydraulic actuator arranged inside the contact terminal and being configured to linearly move the movable contact in the contact terminal in two directions for closing and opening a connection with a contact conductor.

The present invention is at least partly based on the realization of a hydraulic actuator that is arranged in the contact terminal for actuating the moving contact. This allows for simple control system and logics and further simplifies compliance with electromagnetic requirements due to the hydraulic actuator. Moving the moving contact requires only control power, such as 24V, and the force required for moving the contact is instead stored as hydraulic pressure in an accumulator.

### BRIEF DESCRIPTION OF THE SEVERAL VIEWS OF THE DRAWING(S)

FIG. 1A is a cross-section of an alternator current disconnector in an open state in accordance with the present disclosure.

FIG. 1B is a cross-section of an alternator current disconnector in a closed state in accordance with the present disclosure.

FIG. 2 is a diagram of an alternator current disconnector in accordance with the present disclosure.

FIG. 3 is a system schematic of an alternator current disconnector comprising multiple disconnector units in accordance with the present disclosure.

FIG. 4A is a diagram of an alternator current disconnector implemented in a multichannel system in accordance with the present disclosure.

FIG. 4B is a diagram of an alternator current disconnector implemented in a multichannel system in accordance with the present disclosure.

### DETAILED DESCRIPTION OF THE INVENTION

In the present detailed description, various embodiments of the present invention are herein described with reference to specific implementations. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the scope of the invention.

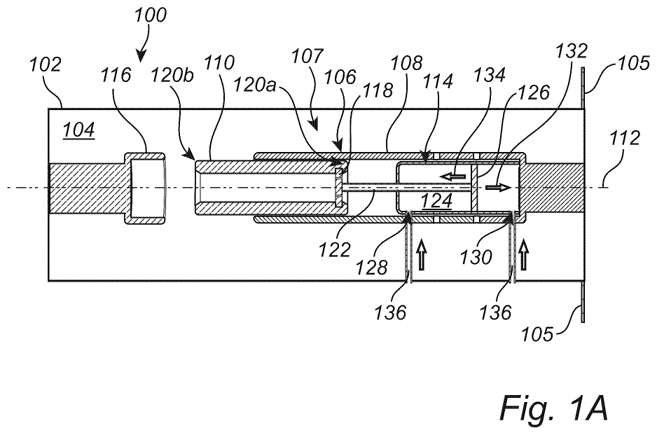

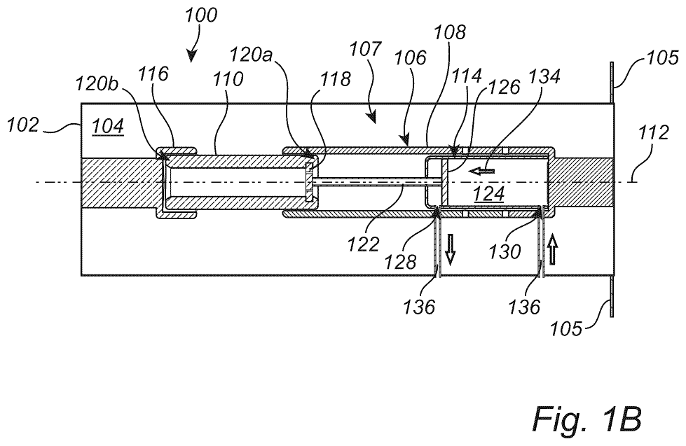

FIG. 1A is a cross-section of an alternator current disconnector 100 according to an embodiment. The alternator current disconnector 100 comprises a watertight housing 102 that is configured to allow for subsea operation of the alternating current disconnector 100. This means that the watertight housing 102 is configured to ensure that liquid is not allowed to penetrate to the internal space 104 of the housing 102, such that the alternator current disconnector 100 can operate in a subsea environment. The watertight housing 102 may be a pressure-resistant housing or a liquid-pressure-compensated housing. As an example, a liquid or gas-pressure-compensated housing may be filled with oil or a gas.

The watertight housing comprises a flange pipe structure 105 configured to provide for mechanical mounting to a secondary structure by for example bolting or using weld joints. The alternator current disconnector 100 further comprises a disconnector unit 107 comprising a contact terminal 106, a movable contact 110, and a linear hydraulic actuator 114.

The contact terminal 106 is accommodated in the housing 102. The contact terminal 106 has an enclosure 108 which may be cylindrical and that is configured as a high voltage conductor that is arranged to conduct electrical current in a closed state of the alternator current disconnector 100.

The movable contact 110 is arranged in the contact terminal 108. The movable contact 110 is movable relative to the enclosure 108. More specifically, the movable contact 110 is movable along the longitudinal axis 112 of the contact terminal 106 in two opposite directions. The motion of the movable contact 110 may be a sliding motion along the longitudinal axis 112. The movable contact 110 can conduct electrical current to the high voltage conductor 108. Preferably, the movable contact 110 is cylindrical.

Furthermore, the linear hydraulic actuator 114 is arranged inside the enclosure 108. The linear hydraulic actuator 114 is configured to linearly move the movable contact 110 in the contact terminal 106 in two opposite directions for closing and opening a connection with between the movable contact 110 and a contact conductor 116. The alternating current disconnector may be arranged to control an electrical connection between two points, such as a local grid and a power generating unit. For this, the contact conductor 116 and the high voltage conductor 108 of the contact terminal 106 may be connected to a respective wet-mated electrical contact (not shown).

The linear hydraulic actuator 114 comprises a movable piston 118 that is attached to the moving electrode 110. When the linear actuator 114 is activated the motion of the piston 118 causes the motion of the moving electrode 110. More specifically, the piston 118 is attached to the moving electrode 110 at its rear end 120a. For example, the piston may be attached in a radially inwards facing slot or groove in the cylindrical moving electrode 110. The moving contact 110 connects with the contact conductor 116 on its opposite side, the front side 120b.

The piston 118 is attached to a rod 122 which reaches into a compartment 124 of the linear hydraulic actuator 114. The compartment 124 houses a hydraulic unit 126 which may be a second piston 126 or another mechanism which may be moved in response to the actuation of the linear hydraulic actuator 114. The hydraulic unit 126 is attached to the piston 118 via the rod 122. The compartment 124 is preferably cylindrical.

Furthermore, the compartment 124 comprises one inlet, a first inlet 128 for pressurizing in the opening direction, and another inlet, a second inlet 130, for pressurizing in the closing direction. In other words, by pressurizing the compartment 124 through the first inlet 128, the hydraulic unit 126 is pushed in a first direction 132, and by pressurizing the compartment 124 through the second inlet 130, the hydraulic unit 126 is pushed in a second direction 134 opposite relative to the first direction 132. These motions of the hydraulic unit 126 cause the piston 118 to move the movable contact 110 in two opposite directions.

Preferably, electrically insulating hoses 136 are connected to the inlets 128 and 130 for providing hydraulic fluid to compartment 124 where the hydraulic unit 126 is arranged.

In FIG. 1A, the alternating current disconnector 100 is in its open state. That is, the movable contact 110 is not in contact with the contact conductor 116. FIG. 1B is a cross-section of the alternating current disconnector 100 shown in FIG. 1A but in its closed position. In other words, hydraulic pressure is supplied to the second inlet 130 which cause movement of the hydraulic unit 126 in the second direction 134 and consequently also the movable contact 110 to the contact conductor 116. In this closed state electric current can flow between the high voltage conductor 108 and the contact conductor 116 via the movable contact 110. The alternating current disconnector 100 is preferably configured to carry sinusoidal electric current having amplitude of at least 400 A, or at least 900 A, or at least 1250 A, or at least 2000 A, in the range of 300 A to 3000 A, in its closed position.

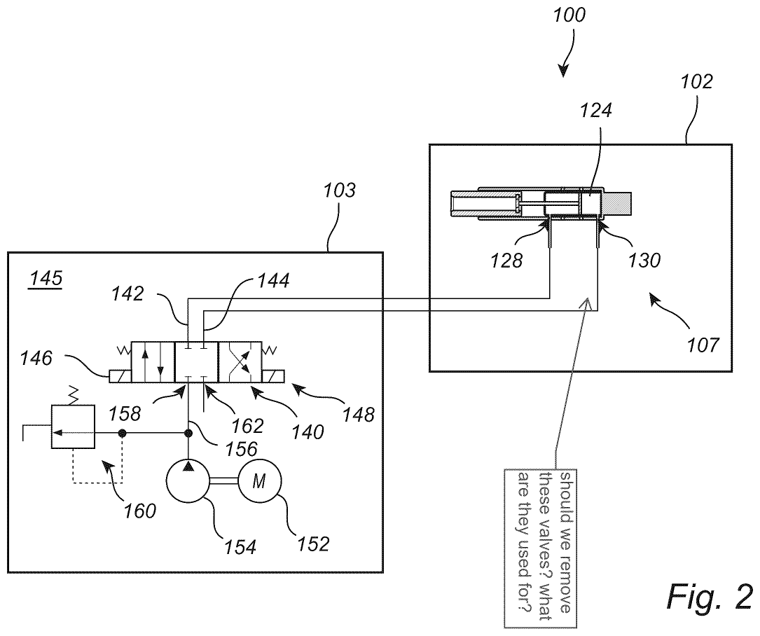

FIG. 2 schematically illustrates the alternating current disconnector 100 including the disconnector unit 107 in the watertight housing 102 (the contact conductor is omitted in FIG. 2). Furthermore, a valve 140 is connected to the inlet 128 and to the inlet 130 of the compartment 124 housing the hydraulic unit 126 via hydraulic lines 142 and 144. The valve 140 is controllable, for example by means of an opening solenoid 146 and a closing solenoid 148. The valve may be a so-called 4/3 directional valve.

A hydraulic pump 152, the valve 140, and an accumulator 154 are arranged in a separate watertight housing 103 with equal or similar pressure resistant properties as the housing 102. The hydraulic pump 152 is configured to pump oil from the internal space 105 of the housing or tank 103 into an accumulator 154. The accumulator 154 is connected via hydraulic line 156 to an inlet 158 of the valve 140. An overpressure valve circuit 160 is connected to the hydraulic line 156 to take care of overpressure oil and redirected it back into the tank 103. The pressure accumulator 154 including the hydraulic pump 152 are immersed in oil serving as a fluid reservoir for the hydraulic pump 152 that is arranged to drive the linear hydraulic actuator 126. Notably, the oil is used for pressure-compensation to allow for subsea operation meaning that no additional source of hydraulic fluid is required. Advantageously, this allows for straight forward implementation of the hydraulic control of the alternating current disconnector 100.

The housing 102 may further accommodate an electrostatic filter to capture particles generated in the contacts under load as known in the art and further described in EP2826565A1. Furthermore, an internal gas cushion system may be arranged in the housing in order to avoid overpressure conditions during installation, testing, or during operation.

During operation, hydraulic fluid is pumped by the hydraulic pump 152 into the accumulator 154 to build up pressure in the accumulator 154. The pressurized hydraulic fluid enters the valve 140. If the opening solenoid 146 is actuated, oil is pumped through line 142 out from the housing 103, to the housing 102, and into the inlet 128. Thereby the piston 126 moves in the direction 132 to open the disconnector 100. Return hydraulic fluid pushed out through inlet 130 is returned to the reservoir 145 though valve return outlet 162.

When the closing solenoid 146 is actuated, oil is pumped through line 144 into the inlet 130. Thereby the piston 126 moves in the direction 134 to close the disconnector 100.

Return hydraulic fluid pushed out through inlet 128 is returned to the reservoir 104 though valve return outlet 162. Note that only hydraulic lines 142 and 144 are required between the housings 102, 103, and still allow for controlling the alternating current disconnector 100, without the need for electrical lines between the housings 102 and 103.

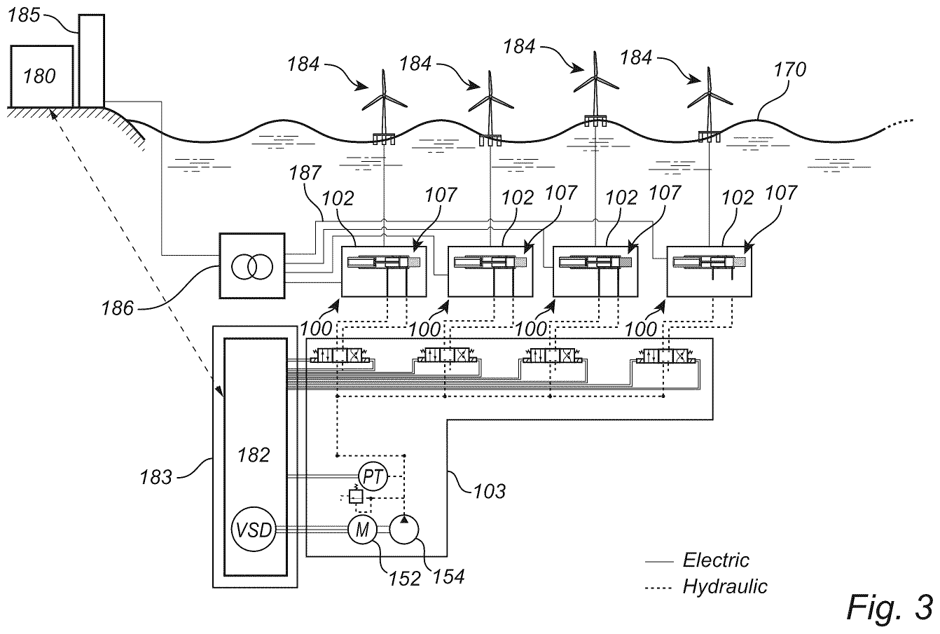

FIG. 3 illustrates alternating current disconnectors 100 comprising disconnector units 107 each in a separate watertight housing 102 accommodating hydraulic fluid in the internal space thereof. The housing 102 is arranged under sea level 170 completely submersed in water, preferably on the seabed.

The alternating current disconnectors 100 are electrically connected to a power generating unit 184 in the form of wind turbines 184. The alternating current disconnectors 100 are further electrically connected to a subsea power transformer 186 configured to convert the power received from the power generation units 184 and provide converted power to a power consumer 185. The alternating current disconnectors 100 are suitable for many different connection topologies with the power generation units 184 and the herein shown configuration is only shown for exemplary purposes. Electrical connections between the alternating current disconnectors 100, the wind turbines 184, and the transformer 186 are through wet-mated connections and electrical subsea cables 187 (only one is numbered).

A separate housing 103 accommodates the hydraulic pump 152 and the accumulator 154. The hydraulic pump 152 and the accumulator 154 are configured to provide hydraulic fluid to all the multiple valves 140 in the housing 103 used for controlling the disconnector units 107 through multiple hydraulic lines.

The valves 140 and the motor 152 are remotely controllable from above sea level by an onshore or offshore control center or control unit 180 that communicates with a subsea control unit 182 arranged in a separate housing 183. The control may be though a so-called variable speed drive, VSD, but other possible implementations are also envisaged. The subsea control unit 182 is configured to control the valves 140, the motor and the accumulator 154 to provide pressurized fluid to the valves 140. This provides for remote control of the hydraulic actuator and thus also the disconnector units 107.

The plurality of alternating current disconnectors 100, each with its separate watertight housing 102, provide for only having to distribute the hydraulic cables (dashed lines) subsea and reduce the need for distributing electric cables 187 (solid lines). The only required control signals are advantageously between the subsea control unit 182, the valves 140, and the motor 152, and they can be placed close to each other, whereas the alternating current disconnectors 100 are likely more sparsely distributed. A pressure transducer, PT may optionally be connected to the hydraulic line from the accumulator 154, for monitoring of the pressure and provide improved pressure control.

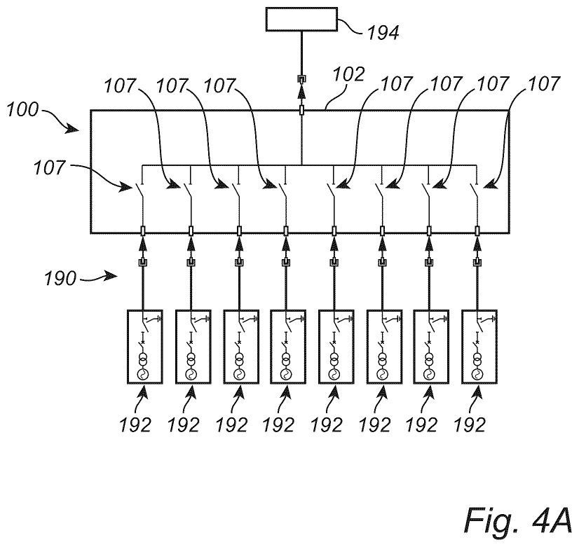

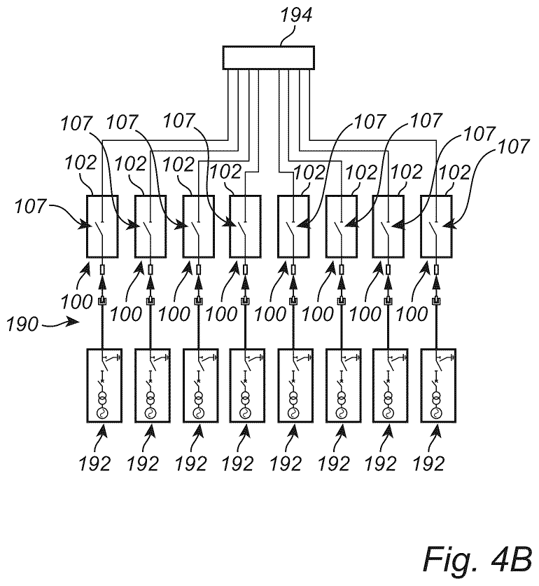

FIG. 4A schematically illustrates an example implementation of the alternating current disconnector 100 to a multichannel system 190, for example comprising multiple offshore power generation units 192, such as floating windmills. The alternating current disconnector 100 are here part of a subsea power collector. The alternating current disconnector 100 comprises multiple disconnector units 107 in a single watertight housing 102.

The alternating current disconnector 100 is configured to isolate offshore power generation units 192 from a power transformer 194 of the power collection system.

In FIG. 4A, multiple disconnector units 107 are arranged in a single watertight housing 102. This may be useful for some implementations, for example where the power generation units 192 are not so many and near each other. However, it will require more and longer electrical cables than for a distributed system of disconnector units 107 in separate housings.

FIG. 4B illustrates such implementation where each alternating current disconnector 100 includes one disconnector unit 107, or possibly two disconnector units 107. In such case, each disconnector unit 107 can be placed very close to the respective power generation unit 192 meaning that only hydraulic lines are needed to the disconnector unit and only relatively short electric cables between the respective alternating current disconnector 100 and the power generating unit 192. The power transformer 194 may be placed close to the alternating current disconnectors 100. Generally, with the configuration shown in FIG. 4B, there is one alternating current disconnector 100 for each power generation unit 192, where each alternating current disconnector 100 comprises the required number of disconnector unit 107 for one power generation unit 192.

FIGS. 4A and 4B are considered a single-phase representation of a multiphase system.

The alternating current disconnector may be configured to isolate a three-phase power system, including but not limited to 11 kV, 36 kV and 72.5 kV in dielectric liquid or gaseous insulation. The linear hydraulic actuator 114 described herein is configured to operate at pressures of at least 10 bar, or at least 20 bar, or in the range of 10 bar to 20 bar.

A control unit may include a microprocessor, microcontroller, programmable digital signal processor or another programmable device. The control unit may also, or instead, include an application-specific integrated circuit, a programmable gate array or programmable array logic, a programmable logic device, or a digital signal processor. Where the control unit includes a programmable device such as the microprocessor, microcontroller or programmable digital signal processor mentioned above, the processor may further include computer executable code that controls operation of the programmable device.

Communication between devices, control units or other modules described herein may be wireless or hardwired, based on electrical and/or fiber-optical communication as is suitable and implement a suitable protocol for the specific case.

In the context of the present disclosure, the contact terminal is preferably fixed in relation to the housing. When the connection is closed, the movable contact is in contact with the contact conductor, and when the connection is open, the movable contact is not in contact with the contact conductor. The movable contact is movable such that it at least partly extends to outside an enclosure of the contact terminal, that is, external to the enclosure, but still inside the watertight housing.

The alternating current disconnector may comprise the contact conductor, for example as part of the disconnector unit. That is, the disconnector unit may comprise the contact conductor. The linear motion of the moving contact means that the motion of the moving contact is along a longitudinal axis, also aligned with the contact terminal physical longitudinal axis.

That the housing is watertight or equally termed water-impermeable means that the housing is adapted to not allow water to enter the inner compartment of the enclosure where the disconnector unit comprising the contact terminal, the movable contact, and the linear actuator are located. Preferably, the housing is metallic and completely welded to avoid water leakage into the enclosure. The housing is preferably made from a corrosive resistant metal.

That the alternating electric current disconnector is for subsea operation means that the alternating electric current disconnector is configured to be submersed in water during operation. In the submersed arrangement, the housing is entirely submersed in water, i.e., below sea level.

The alternating current disconnector may enable controlled off-line individual connection and disconnection of e.g. wind turbine cables from a wind turbine. This may be use for instance during installation, inspection, maintenance, or repair of the wind turbine. Once such operations are complete, the operator can re-start production on the connected turbines from an off-site location.

The contact conductor which connects with the movable contact in the closed position of the disconnector is connected, or connectable, with an external unit or device. External is here outside the watertight housing. For example, the contact conductor may be connected or connectable with a power generation unit or to a local grid.

The watertight housing is equipped with suitable wet-mated electrical connections for connecting the alternating current disconnector with an external cable. For example, the contact conductor may be connected to a wet-mated connection and the contact terminal may be connected to another wet-mated connection.

In embodiments, the linear hydraulic actuator may comprise a movable piston that is attached to the moving electrode, wherein the motion of the piston causes the motion of the moving electrode. Advantageously, the movable piston cause motion of the moving electrode as it is moved by the pressure generated in the linear hydraulic actuator.

Advantageously, the alternating current disconnector may comprise a compartment for housing a hydraulic unit of the linear hydraulic actuator attached to the piston that extends outside the compartment, the compartment comprising one inlet for pressurizing in the opening direction, and another inlet for pressurizing in the closing direction. The hydraulic unit is moved in the cylindrical compartment in the opening direction when hydraulic pressure is applied in one inlet and moved in the opposite direction being the closing direction when hydraulic pressure is applied in the other inlet. This provides a simple yet robust and cost-efficient actuation of the alternating current disconnector.

Furthermore, having the hydraulic unit inside the contact terminal provides for a very compact disconnector.

In embodiments, the alternating current disconnector may comprise electrically insulating hoses that connect to the inlets for providing hydraulic fluid to the hydraulic unit. This advantageously provides for better electromagnetic compliance.

The linear hydraulic actuator may be configured to operate at pressures in of at least 10 bar, or at least 20 bar, or in the range of 10 bar to 20 bar. That is, the pressure applied from a source such as an accumulator is in the above preferred pressure ranges.

In embodiments, the watertight housing comprises a flange pipe structure configured to provide for mechanical mounting to a secondary structure. The flange pipe structure may be a steel pipe with welded end-flanges which facilitate bolted or weld joints to other structures, e.g., for power distribution busbars commonly used subsea for pipelines or manifolds. An advantage may be lower cost compared to welded subsea module steel tanks.

In embodiments, the watertight housing may be a pressure-resistant housing or a liquid-pressure-compensated housing. That the housing is liquid-pressure-compensated means that the enclosure is oil-filled so that the contact terminal is submerged in oil and in contact with oil. There can still be some minor sub-volumes in the housing that are not oil-filled. However, the purpose while filling the housing with oil is to entirely fill the housing, but some pockets without oil are allowed. Preferably, the housing is entirely filled with oil.

The housing can withstand pressures at sea depths where the pressure may be even as high as 150 bar or higher.

In embodiments, the alternating current disconnector may be configured to carry electric current of at least 400 A, or at least 900 A, or at least 1250 , or at least 2000 A, in the range of 300 A to 3000 A, in its closed position. The electric current is preferably a sinusoidal electric current.

In embodiments, the alternating current disconnector may comprise a pressure accumulator including a hydraulic pump immersed in oil being a fluid reservoir for the hydraulic pump that is arranged to drive the linear hydraulic actuator. An electrostatic filter may be arranged in the oil volume below the contact terminal such that it does not disturb the electric field from the disconnector current substantially, the electrostatic filter is arranged to capture particles generated in the contacts under load.

In embodiments, the alternating current disconnector may comprise an internal gas cushion system in the housing to avoid overpressure conditions during installation and testing, and also during operation. A gas cushion introduces compressibility in the system so oil can expand with temperature changes without causing excessively overpressure and tank rupture.

In embodiments, the hydraulic actuator may be remotely controlled from at or above sea level. This advantageously provides for an operator above sea level to control the alternating current disconnector.

The alternating current disconnector may be connectable to an offshore power generation unit. The alternating current disconnector may be configured to open and close a connection between the offshore power generation unit and a local grid that may be subsea or an onshore local grid. The alternating current disconnector may thus be comprised in a subsea power collector configured to collect electrical power from the offshore power generation unit.

An offshore power generation unit may be floating windmills, e.g. comprising a wind turbine for converting wind power into electric power. However, it should be understood that the power generation units may equally well be e.g. floating solar power modules, or floating wave or tidal power modules arranged offshore in a floating formation.

In embodiments, multiple disconnector units are arranged in one watertight housing.

Advantageously, each of the multiple disconnector units may be individually controllable by a remotely controlled valve system and a common pressure accumulator.

Advantageously, each of the multiple disconnector units may be individually controllable by a redundant system of valves and pressure accumulators.

In embodiments, the alternating current disconnector may be configured to isolate one phase in a three-phase system, including but not limited to 11 kV, 36 kV and 72.5 kV in dielectric liquid or gaseous insulation.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An alternating current disconnector, comprising:
a watertight housing for subsea operation of the alternating current disconnector;
a disconnector unit comprising:
a contact terminal accommodated in the housing;
a movable contact arranged in the contact terminal and being movable relative to the contact terminal; and
a linear hydraulic actuator arranged inside the contact terminal and being configured to linearly move the movable contact in the contact terminal in two directions for closing and opening a connection with a contact conductor.

2. The alternating current disconnector according to claim 1, wherein the linear hydraulic actuator comprises a movable piston that is attached to the moving electrode, wherein the motion of the piston causes the motion of the moving electrode.

3. The alternating current disconnector according to claim 2, further comprising a compartment for housing a hydraulic unit of the linear hydraulic actuator attached to the piston that extends outside the compartment, the compartment comprising one inlet for pressurizing in the opening direction, and another inlet for pressurizing in the closing direction.

4. The alternating current disconnector according to claim 3, further comprising electrically insulating hoses that connect to the inlets for providing hydraulic fluid to the hydraulic unit.

5. The alternating current disconnector according to claim 1, wherein the linear hydraulic actuator is configured to operate at pressures of at least 10 bar.

6. The alternating current disconnector according to claim 1, wherein the watertight housing comprises a flange pipe structure configured to provide for mechanical mounting to a secondary structure.

7. The alternating current disconnector according to claim 1, wherein the watertight housing is a pressure-resistant housing or a liquid-pressure-compensated housing.

8. The alternating current disconnector according to claims 1, further configured to carry electric current of at least 400 A when in the closed position.

9. The alternating current disconnector according to claim 1, further comprising a pressure accumulator and a hydraulic pump immersed in oil being a fluid reservoir for the hydraulic pump that is arranged to drive the linear hydraulic actuator.

10. The alternating current disconnector according to claim 1, wherein the hydraulic actuator is remotely controlled from or at above sea level.

11. The alternating current disconnector according to claim 1, wherein the disconnector unit is connectable to an offshore power generation unit.

12. The alternating current disconnector according to claim 1, further comprising additional disconnector units disposed in the watertight housing.

13. The alternating current disconnector according to claim 12, wherein each of the additional disconnector units is individually controllable by a remotely controlled valve system and a common pressure accumulator.

14. The alternating current disconnector according to claim 12, wherein each of the multiple disconnector units is individually controllable by a redundant system of valves and pressure accumulators.

15. The alternating current disconnector according to claim 1, wherein the disconnector unit is configured to isolate a multichannel system.
